(19) United States
(12) Patent Application Publication
(10) Pub. No.: US 2016/0341272 A1
(43) Pub. Date: Nov. 24, 2016

(54) SHOCK ABSORBER

(71) Applicant: KYB CORPORATION, Tokyo (JP)

(72) Inventors: Toshiharu KAWABE, Aichi (JP); Satoru TAKEO, Gifu (JP)

(73) Assignee: KYB Corporation, Tokyo (JP)

(21) Appl. No.: 15/114,493

(22) PCT Filed: Feb. 4, 2015
(86) PCT No.: PCT/JP2015/053111

§ 371 Date: Jul. 27, 2016

(30) Foreign Application Priority Data
Feb. 6, 2014 (JP) 2014-021156

(51) Int. Cl. F16F 9/38; F16F 9/19

(52) U.S. Cl. CPC F16F 9/38; F16F 9/19

(57) ABSTRACT

The shock absorber includes an outer tube having one end and an outer periphery where a piston rod extends from the one end, and a convex portion is formed on the outer periphery, a spring sheet press-fitted to the convex portion, and a bracket that is secured to the spring seat and holds one end of a dust boot protecting the piston rod.

### TECHNICAL FIELD

The present invention relates to a shock absorber.

### BACKGROUND ART

has disclosed a shock absorber that fits a spring seat including a cylinder portion with a closed bottom into an outer tube from a side where a piston rod extends. A protrusion holding one end of a dust boot is disposed on the cylinder portion of the spring seat. The spring seat is positioned in a state where a bottom surface of the cylinder portion abuts on an end surface of the outer tube.

### SUMMARY OF INVENTION

At the above-described shock absorber, the axially lengthened cylinder portion of the spring seat increases weight, and formation of the spring seat itself becomes difficult, depending on a position of a spring seat surface and a position holding the dust boot. This causes a problem of a low degree of freedom for setting with respect to the position of the spring seat surface and the position holding the dust boot.

Therefore, it is considered to ensure the degree of freedom for setting of the position of the spring seat surface and the position holding the dust boot by individually disposing the spring seat as the spring seat surface and a bracket including a dust boot holding portion.

Here, a method securing the spring seat to the outer tube is examined. When the spring seat is secured to an outer periphery of the outer tube by welding, an uncoated portion will occur at a back side of the spring seat in a subsequent electrostatic coating. In view of this, it is preferable to dispose a convex portion where the spring seat is press-fitted, at the outer periphery of the outer tube, and then press-fit the spring seat to the convex portion of the outer tube after individually coating with the outer tube, that is, a main body of the shock absorber and the spring seat, in order to secure the spring seat to the outer tube.

On the other hand, it is considered that the bracket is secured to the outer periphery of the outer tube by welding. However, since welding is performed before coating with the outer tube as described above, if the bracket is secured to the outer tube by welding, an inner peripheral side of the spring seat interferes with the bracket. This makes installing the spring seat after coating with the outer tube impossible. Accordingly, when the bracket is secured to the outer tube by welding, the coating has to be performed after securing the spring seat to the outer tube. This causes a problem generating an uncoated portion.

An object of the present invention is to provide a shock absorber that ensures the degree of freedom for setting of the position of the spring seat surface and the position holding the dust boot, and facilitates the coating.

According to one aspect of the present invention, a shock absorber includes a cylinder with one end and an outer periphery where a piston rod extends from the one end and a convex portion is formed on the outer periphery, a spring sheet press-fitted to the convex portion, and a bracket that is secured to the spring seat and holds one end of a dust boot protecting the piston rod.

### BRIEF DESCRIPTION OF THE DRAWINGS

FIG. 1 is a partial cross-sectional view illustrating a shock absorber according to an embodiment of the present invention.

### DESCRIPTION OF EMBODIMENTS

The following describes a shock absorber 100 according to an embodiment of the present invention with reference to the drawing.

The shock absorber 100 is, for example, a device that is interposed between a body and an axle shaft of a vehicle (not illustrated) and generates damping force to reduce vibration of the vehicle body. The shock absorber 100 has one end mounted on the vehicle via a mount member (not illustrated) coupled to an end portion of a piston rod 2 that extends from an outer tube 1 as a cylinder. The shock absorber 100 has the other end attached on the vehicle by an attaching member 1a disposed on the outer tube 1.

The shock absorber 100 is, what is called a twin-tube shock absorber. The piston rod 2 is inserted freely back and forth into an inner tube (not illustrated) arranged in the outer tube 1.

A spring seat 3 is secured to an outer periphery of the outer tube 1. A bracket 4 secured to the spring seat 3 holds one end of a dust boot 5 that protects the piston rod 2. The other end of the dust boot 5 is, for example, held by the mount member.

A detail description will be given in the following.

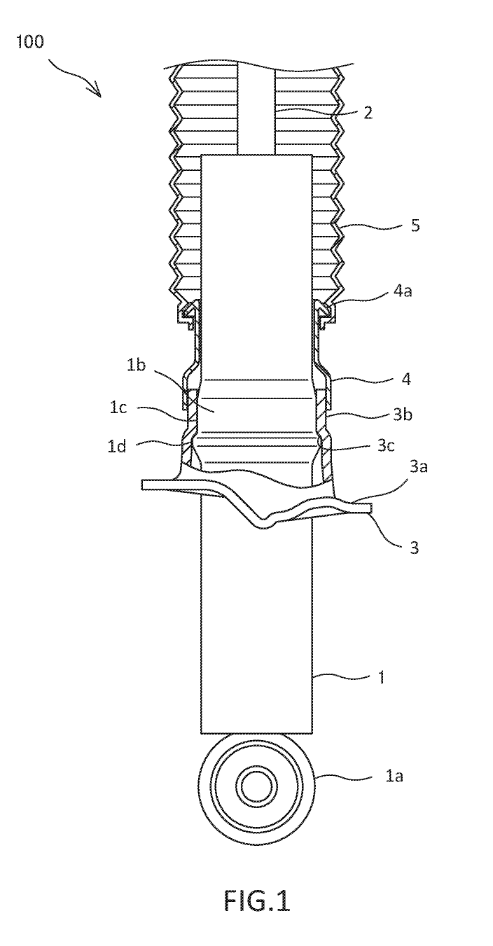

A convex portion 1b is formed on the outer periphery of the outer tube 1. The convex portion 1b, as illustrated in FIG. 1, includes a press-fitted portion 1c where the spring seat 3 is press-fitted and a lock portion 1d formed to project with respect to the press-fitted portion 1c.

In the embodiment, the convex portion 1b is disposed on a whole circumference of the outer tube 1. This makes a state where the outer tube 1 is radially expanded. The convex portion 1b, for example, may be disposed by separating it into several pieces in a circumferential direction of the outer tube 1.

The spring seat 3 includes a spring seat surface 3a and a cylinder portion 3b disposed on an inner peripheral side of the spring seat surface 3a. The spring seat 3 is press-fitted to the press-fitted portion 1c of the outer tube 1 from a side where the piston rod 2 extends. A position of the spring seat 3 is specified by a position where a stepped portion 3c formed on the cylinder portion 3b abuts on the lock portion 1d of the outer tube 1. Accordingly, changing a position of the convex portion 1b of the outer tube 1 ensures a free setting of the position of the spring seat 3, that is, a position of the spring seat surface 3a.

The cylinder-shaped bracket 4 is secured to the cylinder portion 3b of the spring seat 3 by welding.

A lock portion 4a that grapples an opening portion of the dust boot 5 from an inside is formed on an end portion of the bracket 4 at a side of the dust boot 5. Thus, an end portion of the dust boot 5 at a side of the spring seat 3 is held by the bracket 4. The lock portion 4a may be disposed on the whole circumference of the bracket 4, or may be disposed by separating it into several pieces in a circumferential direction of the bracket 4.

Since the bracket 4 is secured to the spring seat 3 by welding as described above, if the position of the spring seat 3 is changed, a position holding the dust boot 5 is changed together. Here, when only the position holding the dust boot 5 is desired to change, use of another bracket where a position of a lock portion is different from that of the bracket 4 ensures free setting of the position holding the dust boot 5 regardless of the position of the spring seat 3.

Subsequently, the following describes an installing method of the shock absorber 100.

At the shock absorber 100, the outer tube 1 is coated before installing the spring seat 3, the bracket 4, and the dust boot 5. The spring seat 3 and the bracket 4 are coated after being secured by welding.

Thus, coating with the outer tube 1 in a state where the spring seat 3 is not installed ensures an all surface coating of the outer tube 1 by applying a low-cost electrostatic coating. Electrodeposition coating, which can coat even with inner peripheral sides, is applicable to the spring seat 3 and the bracket 4. This facilitates the coating of the shock absorber 100 without generating an uncoated portion.

After completion of the coating, the spring seat 3 where the bracket 4 is secured is press-fitted to the convex portion 1b of the outer tube 1.

Then, the end portion of the dust boot 5 at the spring seat 3 side is grappled by the lock portion 4a of the bracket 4 to complete the installation of the shock absorber 100.

As described above, according to the embodiment, individually disposing the spring seat 3 and the bracket 4 holding the one end of the dust boot 5 ensures the free setting of the position of the spring seat surface 3a and the position holding the dust boot 5.

More specifically, changing the position of the convex portion 1b of the outer tube 1 ensures the free setting of the position of the spring seat 3, that is, the position of the spring seat surface 3a. Use of another bracket where the position of the lock portion is different from that of the bracket 4 ensures the free setting of the position holding the dust boot 5 regardless of the position of the spring seat 3.

Securing the bracket 4 to the spring seat 3 ensures individual coatings of the outer tube 1 and the spring seat 3 before press-fitting the spring seat 3 to the outer tube 1. Accordingly, the shock absorber 100 can be easily coated without generating an uncoated portion.

The embodiment of the present invention has been described above, however the above-described embodiment only indicates a part of an application example of the present invention, and not intend to limit the technical range of the present invention to the concrete example of the above-described embodiment.

In the above-described embodiment, the lock portion 4a disposed on the bracket 4 holds the dust boot 5. However, the method that causes the bracket 4 to hold the dust boot 5 is not limited to this. For example, a structure that causes the bracket 4 to hold the dust boot 5 by fastening the dust boot 5 from an outside with a band in a state covering the dust boot 5 on an outer periphery of the bracket 4 is possible.

The bracket 4 is secured to the spring seat 3 by welding. However, since it is only necessary that the bracket 4 is not removed by the vibration in vehicle-running and tensile force when the dust boot 5 extends, for example, the bracket 4 may be secured by press-fitting into the cylinder portion 3b of the spring seat 3.

The coatings of the spring seat 3 and the bracket 4 are performed after welding the spring seat 3 and the bracket 4. However, when securing the bracket 4 to the spring seat 3 by press-fitting as described above, the press-fitting may be performed after individually coating with the spring seat 3 and the bracket 4. When individually coating with the spring seat 3 and the bracket 4, the bracket 4 may be press-fitted to the spring seat 3 after press-fitting the spring seat 3 to the outer tube 1, or the bracket 4 may be press-fitted to the spring seat 3 before press-fitting the spring seat 3 to the outer tube 1.

The present application claims a priority based on Japanese Patent Application No. 2014-21156 filed with Japan Patent Office on Feb. 6, 2014, all the contents of which are hereby incorporated by reference.

1. A shock absorber comprising:
a cylinder having one end and an outer periphery, a piston rod extending from the one end, and a convex portion being formed on the outer periphery;
a spring sheet press-fitted to the convex portion; and
a bracket that is secured to the spring seat and holds one end of a dust boot protecting the piston rod, wherein
the bracket has another end portion at an opposite side of the end portion at the dust boot side, the another end portion of the bracket is secured to the end portion of the dust boot side of spring seat.

2. The shock absorber according to claim 1, wherein
the bracket is placed along the outer periphery of the cylinder.

3. The shock absorber according to claim 1, wherein
the bracket is made of metal.

4. The shock absorber according to claim 1, wherein
the another end portion of the bracket is secured to the end portion of the dust boot side of spring seat by welding.

5. The shock absorber according to claim 1, wherein
the another end portion of the bracket is secured to the end portion of the dust boot side of spring seat by press-fitting.

6. The shock absorber according to claim 1, wherein
the bracket includes a lock portion that grapples an end portion of the dust boot at an end portion of the dust boot.

7. The shock absorber according to claim 1, wherein
the bracket has another end portion at an opposite side of the end portion at the dust boot side, the other end portion having an inner diameter larger than an inner diameter of the end portion at the dust boot side.

8. The shock absorber according to claim 1, wherein
the spring seat includes a cylinder portion positioned at the dust boot side and press-fitted to the convex portion of the cylinder, and a spring seat surface positioned at an opposite side of the dust boot.
